(19) United States
(12) Patent Application Publication
(10) Pub. No.: US 2020/0363704 A1
(43) Pub. Date: Nov. 19, 2020

(54) EASY TO USE, MULTI-FUNCTIONAL SHOOTING SYSTEM

(71) Applicants: Faruk SAÇAN, Gölcük, Kocaeli (TR); Hakan FIRTINA, Çanakkale (TR)

(72) Inventors: Faruk SAÇAN, Gölcük, Kocaeli (TR); Hakan FIRTINA, Çanakkale (TR)

(21) Appl. No.: 16/640,188

(22) PCT Filed: Aug. 28, 2018
(86) PCT No.: PCT/TR2018/050447

§ 371 Date: Feb. 19, 2020

(30) Foreign Application Priority Data
Aug. 29, 2017 (TR) 2017/12974

(51) Int. Cl. G03B 17/56; H04N 5/232; H04N 5/225; G06F 3/01; G06F 3/16; H04B 1/3877; F16M 11/04; F16M 11/10; F16M 11/20; F16M 11/18; F16M 13/02; F16M 13/04; F16M 11/22

(52) U.S. Cl. CPC G03B 17/561; H04N 5/23299; H04N 5/2253; H04N 5/23203; G06F 3/017; G06F 3/167; F16M 11/22; F16M 11/041; F16M 11/105; F16M 11/2064; F16M 11/18; F16M 13/022; F16M 13/04; H04B 1/3877

(57) ABSTRACT

Disclosed is an easy to use, multi-functional shooting system that can be used in any and all indoor and outdoor locations, to which devices capable of taking pictures and/or shooting video can be adapted. A method is also disclosed for operation of this system.

### TECHNICAL FIELD

Invention relates to an easy to use, multi-functional shooting system that can be used in any and all indoor and outdoor locations, to which devices having feature of taking pictures and/or shooting video by means of one or more than one optics it has can be adapted, and a method for it.

### STATE OF THE ART

Upon progress in technology, taking photos and shooting videos and sharing them by users have all been increasing gradually.

Today the auto-portrait photos or videos taken/shot by a digital camera or camera mobile phone by users are called selfies. Such photos or videos are taken from daily events in general and by camera from above at arm distance.

Today users use apparatus called selfie rod to take photo and video at wider angles. Said apparatus has multiple various features and can generally be extendable. Said rods have handle on one end and a clamp keeping fixed device of taking pictures and/or shooting video on the other end.

In addition to them, in today's world, although technological devices in continued development are useful to users, they can also be dangerous for users subject to place and time of uses. Users may sometimes make video calls by their smart phones while driving. Use of smart phones holding in hand while driving causes life safety risk not only for them but also those around them.

Users need selfie systems of various functions in order to take easy and non-dangerous selfie or video calls. For that reason, systems that can be mounted onto car, desk, wall and can be located on ground in outdoor when required and easy to use by sound, hand motions or command (joystick) are needed.

Patent application numbered CN106603778 in the literature discloses a selfie rod providing easy use. The telephone mounted on rod takes video or photo when the button on said rod is pressed in different ways. Said document does not disclose an embodiment easy to use by user by help of sound, hand motions or command.

As a result, due to above described disadvantages and inadequacy of existing solutions, it has been necessary to make development in the related art.

### PURPOSE OF THE INVENTION

The invention has been developed with inspiration from existing situation and aims to eliminate the above mentioned disadvantages.

The main purpose of the invention is not only selfie system. User may take picture-video of any perspective s/he wishes by use of specified functions. Also s/he may rotate the device to any angle, semi/full autonomous angle and share in social media. The device can track its autonomy during video call or live broadcast (instagram/periscope etc.). Our device is adapted selfie rod tripod etc. products by use of connection apparatus and offers opportunity for use in any place.

The purpose of this invention is to provide easy use by sound, hand motion or command by user.

Another purpose of the invention is to provide face/object tracking function.

In order to achieve the above mentioned purposes, the invention relates to a multi-functional shooting system easy to use, wherein devices are adapted, consisting of
At least one holder where users place their phone, camera and other similar optic devices,
At least one primary engine providing to put said holder parallel or vertical position to ground,
At least one secondary engine providing positioning said holder and said primary engine up and down, that is, vertically,
At least one third engine providing positioning of said holder, said primary engine and secondary engine right and left, that is, horizontal positioning.
At least one connecting apparatus providing fixing to car, desk, wall or when required positioning on ground in outdoor,
At least one mechanical adapter providing mounting of said connecting apparatus mechanically,
and that can be used in any indoor and outdoor places, capable to take picture and/or video shooting by means of one or more than one optic it has.
And it is characterized in that at least a primary arm located between said secondary engine and said third engine, mechanically and/or automatically extending shortening,
At least a secondary arm located at end of said third engine, providing change in perspective of optic device located to said holder and offering easy use on tilted surface where mounted,
At least a hardware unit providing detection of user's audio command or hand motions and bringing optic device to desired position and providing automatic track of user in picture/video taking and picture/video shootings or video calls by means of sound, optic sensors, wire and wireless connecting apparatus, electronic control unit and applications located therein.

### BRIEF DESCRIPTION OF THE DRAWINGS

FIG. 1 is a perspective view of an embodiment of multi functional shooting system of the invention.

FIG. 2 is a perspective view of another embodiment of multi functional shooting system of the invention.

FIG. 3 is a perspective view of another embodiment of multi functional shooting system of the invention.

### DESCRIPTION OF PART REFERENCES

1. Shooting system
2. Holder
3. Primary engine
4. Secondary engine
5. Third engine
6. Connecting apparatus
7. Mechanical adapter
8. Primary arm
9. Secondary arm
10. Hardware unit
11. Command
   111. Command arm
   112. Moving button
   113. Shooting button
   114. Box
O. Optic device

### DETAILED DESCRIPTION OF THE INVENTION

In this detailed description, the preferred embodiments of a shooting system (1) and its method disclosed under the invention have been disclosed solely for the purpose of better understanding of the subject.

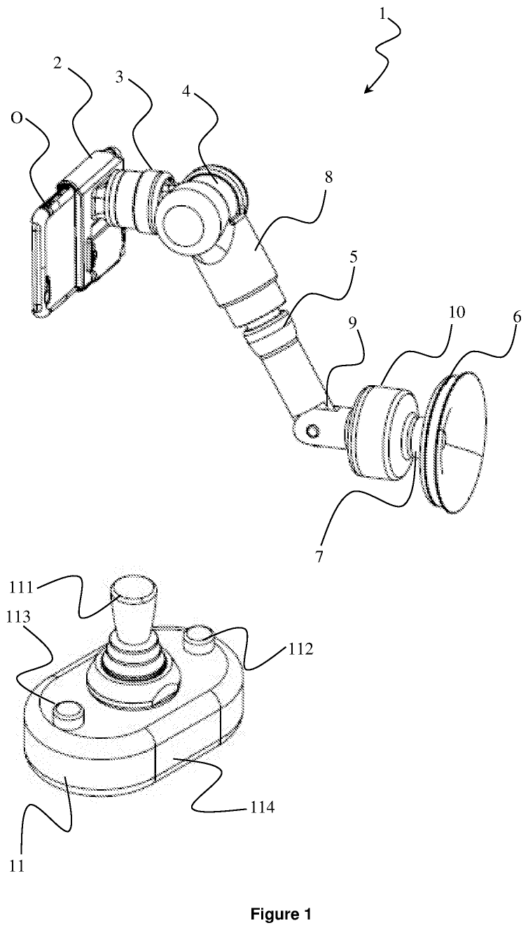

It is a multifunctional shooting system (1) easy to use, wherein devices are adapted and that can be used in any indoor and outdoor places, capable to take picture and/or video shooting by means of one or more than one optic it has, and it consists of
at least a holder (2) where users place their optical devices (O) such as phone, camera and other similar optic devices,
at least a primary engine (3) providing to put said holder (2) parallel or vertical position to ground,
at least a secondary engine (4) providing positioning said holder (2) and said primary engine (3) up and down, that is, vertically,
at least a third engine (5) providing positioning of said holder (2) said primary engine (3) and secondary engine (4) right and left, that is, horizontal positioning.
at least a connecting apparatus (6) providing fixing to car, desk. Wall or when required on ground in outdoor,
at least a mechanical adapter (7) providing mounting of said connecting apparatus (6) mechanically,
at least a primary arm (8) located between said secondary engine (4) and said third engine (5), mechanically and/or automatically extending shortening,
at least a secondary arm (9) located at end of said third engine (5), providing change in perspective of optic device (O) located to said holder (3) and offering easy use on tilted surface where mounted,
at least a hardware unit (10) providing detection of user's audio command or hand motions and bringing optic device (O) to desired position and providing automatic track of user in picture/video taking and picture/video shootings or video calls by means of sound, optic sensors, wire and wireless connecting apparatus, electronic control unit and applications located therein (FIG. 1).

In the system (1) disclosed under the invention has optic devices such as smart phone, camera and similar ones are adapted and electronic control of optic devices (O) is provided. It aims to bring the optic device (O) by hardware unit (10) to desired position upon detection of sound command or hand motions of the user and provide taking pictures or shooting video in the brought position. In addition, it provides sharing taken pictures/videos on social media or message applications by means of the hardware unit (10).

In an embodiment of the invention, the functions of the hardware unit (10) are commanded by means of at least a command (11) communicating with the hardware unit (11) via wire or wireless. Preferably said command (11) consists of at least a command arm (111) used for horizontal and vertical positioning functions of the optic device (O), at least a moving button (112) providing vertical or horizontal positioning of primary engine (3) in respect to ground, at least a shooting button (113) providing shooting picture/video of the optic device (O), at least a box (114) hosting electronic accessories.

In a preferred embodiment of the invention, the primary engine (3) has feature of gyro(stabilization). Thanks to this feature, while in motion, the vibrations are met in counter direction in driver algorithm of primary engine (3) and shake of the optic device (O) and having unclear picture/video. In said embodiment, gyro feature of the primary engine (3) can be turned on/off by buttons located on hardware unit (10) and motion button (112) located on command (11).

Connecting apparatus (6) in embodiment of the invention is a ventouse. In the said embodiment, operation of fixing onto non-porous surfaces such as car window, car console, desk, wall and similar surfaces by help of ventouse.

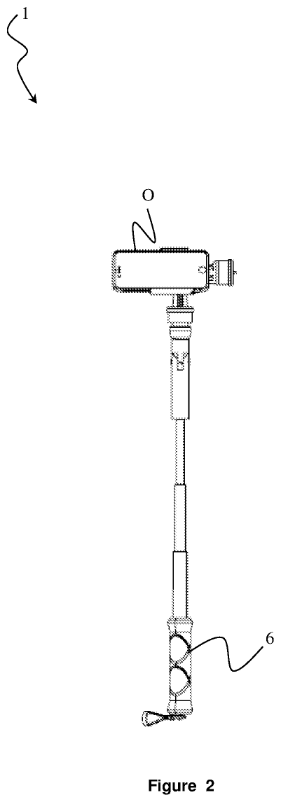

In another embodiment of the invention, connecting apparatus (6) is a shooting rod (FIG. 2). In said embodiment, the user can take wide angle photo/video by help of the shooting rod.

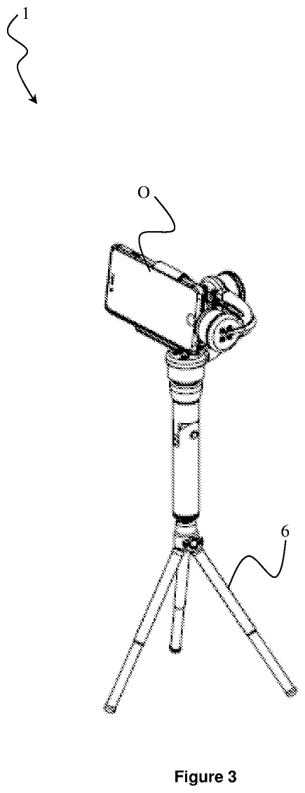

In another embodiment of the invention, connecting apparatus (6) is a tripod (FIG. 3). In said embodiment, user can place the system (1) on ground in indoor or outdoor space.

In the system (1) disclosed under the invention, optic device (O) can be directed to desired direction with user's ‘turn right (or left)’ sound command. When optic device (O) comes to position/angle, user's ‘stop’ command and then ‘photo/video’ command, the picture/video can be taken. The commands given here are only for illustrative purposes. Said commands are created as desired and are installed into electronic unit in the hardware unit (10) and application in advance. The optic device (O) is put into desired position without touching with hand and when the desired position is reached, photo/picture is taken. Said directions are not only to right/left as per user's request but also up/down and positioning optic device (O) in a manner providing its vertical or parallel position in respect to ground. Such directions can be conducted by hand motions or command (111) as desired by user.

The system disclosed under the invention firstly opens the user system (1) in the method providing operation of the system (1). Upon opening of the system (1) by user, hardware unit (10) makes calibrations required or the system.

Then user determines how s/he will control the system (1). If user selects control sound, audio commands of the user are recognized by the hardware unit (10).

When commanding the system (1) by voice, the commands wanted by the user are executed when the words preinstalled and predefined in the application are heard. When sound command is given by user, sound sensor in hardware unit (10) detects sound. The related operations are applied to the system (1) by words pre-installed into the application in the hardware unit (1). For instance, upon commands from the hardware unit (10) when it is commanded as “turn right, stop”, the third engine (5) providing horizontal motion and while turn ‘down’ stop’ orders are given secondary engine (4) and primary engine (3) providing stay of holder (2) horizontal or vertical in respect to ground executes functions. The user may change perspective of the optic device (O) by extending and shortening primary arm (8) and giving angle in up and down direction to the secondary arm (9) making mechanical angle. Another purpose of the secondary arm (9) is to keep the holder (2) in the most convenient position according to slope of the window (each car model windshield and back glasses is different) where it is adapted by ventouse for in care use.

While the system (1) is controlled by optic, the hardware unit (10) detects human face tracking ad hand motions shape in directions of human actions and perceives what user wants and does it. In commanding provided in this way, movements are detected by optic device (O) camera or optic sensors located in hardware unit (10). For instance, when user moves his/her hand to right/left and up/down, sensor located in the hardware unit (10) detects the movement and the application located in the hardware unit (10) brings the optic device (O) to required position. The hardware unit (10) drives the third engine (5) moving right/left on horizontal and vertical axis and the secondary engine (3) moving up and down and thus optic device (O) comes to the position desired by user. When user approaches leaves away his/her hand to/from the optic device (O), execution of zoom in or zoom out in image is performed over the optic device (O) by means of the hardware unit (1).

Wire or wireless communication between the hardware unit (10) and the optic device (O) is executed.

When user starts video call (for instance whatsapp or instagram live chat) at any place (car, home, office, social media programs etc.), track of user continuously by the optic device (O) is provided by optic sensor on the hardware unit (1). The hardware unit (11) is directed by primary engine (3), secondary engine (4) and third engine (5). Thus even the user is moving, optic device (O) always watches user.

While the system (1) is controlled by the command (11), wire or wireless communication is executed between the command (11) and the hardware unit (11). Moving buttons (111) commands primary engine (3) providing vertical or parallel stay of the holder (2) to the ground subject to user's selection. With said moving buttons (111), gyro (stabilisation) feature of the primary engine (3) can be turned on/off. For instance, user fixing the system to car window by ventouse is in motion and records the road. When s/he comes to a slope bend, if gyro selection is active, the image record at the bend will not be same as slope of car since optic device (O) will be parallel to ground. Or when at a hole road and user activates gyro selection, image record will not be fixed because of vibrations. For that reason, gyro selection is left to user's selection. When command arm (111) is moved right/left, up/down, the hardware unit (11) drives secondary engine (4) and third engine (5) and provides bringing the optic device to desired position. User can take pictures/videos by means of shooting button (113).

1. A multi-functional shooting system comprising:
at least one holder where users place their optical devices such as phone, camera and other similar optic devices;
at least one primary engine providing to put said holder parallel or vertical position to ground;
at least one secondary engine providing positioning said holder and said primary engine up and down, that is, vertically;
at least one third engine providing positioning of said holder said primary engine and secondary engine right and left, that is, horizontal positioning;
at least one connecting apparatus providing fixing to car, desk, wall or when required positioning on ground in outdoor;
at least one mechanical adapter providing mounting of said connecting apparatus mechanically, and capable for use in any and all indoor and outdoor spaces, capable to take photo and/or shoot video by means of one or more than one optic it has, can be adapted, easy to use and characterised by comprising:
at least one primary arm located between said secondary engine and said third engine, mechanically and/or automatically extending shortening;
at least one secondary arm located at end of said third engine, providing change in perspective of optic device located to said holder and offering easy use on tilted surface where mounted;
at least one hardware unit providing detection of user's audio command or hand motions and bringing optic device to desired position and providing automatic track of user in picture/video taking and picture/video shootings or video calls by means of sound, optic sensors, wire and wireless connection apparatus, electronic control unit and applications located therein.

2. The system according to claim 1, comprising at least one command commanding functions of the hardware unit by wire or wireless communication of the hardware unit.

3. The system according to claim 1 and it is characterized in that at least a command arm used for horizontal and vertical positioning functions of the optic device, at least a moving button providing vertical or horizontal positioning of said primary engine in respect to ground, at least a shooting button providing shooting picture/video of the optic device, at least a command having at least a box hosting electronic accessories.

4. The system according to claim 1 and it is characterized in that the primary engine having gyro feature of allowing turning on/off by means of buttons in said hardware unit or said moving button located on said command.

5. The system according to claim 1, characterized in that the connecting apparatus is a ventouse providing fixing onto non-porous surfaces such as car window, car console, table, wall and similar surfaces

6. The system according to claim 1, characterized in that the connecting apparatus is a shooting rod.

7. A system according to claim 1, characterized in that the connecting apparatus is a tripod.

8. A multifunctional shooting method which is easy to use, wherein devices are adapted and that can be used in any indoor and outdoor places, capable to take picture and/or video shooting by means of one or more than one optic it has, and it is characterized by comprising process steps of:
conduct of required calibrations by means of a hardware unit;
detection of user assigned controller by means of the hardware unit;
if user selects sound control, recognition of audio commands of the user by the hardware unit;
bringing the optic device to desired position and angle in line with detected audio command by means of the hardware unit;
start of taking picture/shooting video by the optic device (in line with detected audio command by means of the hardware unit;
if user selects hand control, recognition of hand motions of the user by the hardware unit;
bringing the optic device to desired position and angle in line with detected hand motions by means of the hardware unit;
start of taking picture/shooting video by the optic device in line with detected hand motions by means of hardware unit;
if users selects control by command, detection of signals from the command via the hardware unit;
bringing the optic device to desired position and angle in line with detected signals by means of hardware unit;
start of taking picture/shooting video by the optic device in line with detected signals by means of the hardware unit.
